(19) United States
(12) Patent Application Publication
(10) Pub. No.: US 2026/0134776 A1
(43) Pub. Date: May 14, 2026

(54) PARKING INFORMATION PROVIDING METHOD

(71) Applicant: TOYOTA JIDOSHA KABUSHIKI KAISHA, Toyota-shi (JP)

(72) Inventors: Kyosei Sugiyama, Tokyo (JP); Hirofumi Morishita, Anjyo-shi (JP)

(73) Assignee: TOYOTA JIDOSHA KABUSHIKI KAISHA, Toyota-shi (JP)

(21) Appl. No.: 19/338,531

(22) Filed: Sep. 24, 2025

(30) Foreign Application Priority Data
Nov. 11, 2024 (JP) 2024-197002

(51) Int. Cl. G08G 1/14

(52) U.S. Cl. CPC G08G 1/141

(57) ABSTRACT

A parking information providing method executed by an information processing device includes acquiring information regarding a vehicle model that is desired by a customer, and information regarding a planned parking location, determining whether the vehicle model that is desired by the customer is parkable at the planned parking location, based on the information regarding the vehicle model, the information regarding the planned parking location, and a database related to vehicle model information and parking location information, and presenting determination results.

### CROSS-REFERENCE TO RELATED APPLICATION

This application claims priority to Japanese Patent Application No. 2024-197002 filed on Nov. 11, 2024. The disclosure of the above-identified application, including the specification, drawings, and claims, is incorporated by reference herein in its entirety.

### BACKGROUND

### 1. Technical Field

The present disclosure relates to a parking information providing method.

### 2. Description of Related Art

Conventionally, there is known technology for analyzing contents of business negotiations. For example, Japanese Unexamined Patent Application Publication No. 2019-28910 (JP 2019-28910 A) discloses a dialogue analysis system that checks whether a sales representative in business negotiations with a customer communicates matters that should be communicated, and does not state matters that should not be stated.

### SUMMARY

Information during business negotiations can be analyzed using machine learning and so forth. When business negotiations or the like are performed regarding a vehicle, information as to whether the customer can park the vehicle at the location where he/she intends to use the vehicle (hereinafter referred to as parking information) is important, but in the related art, providing parking information has not been taken into consideration. That is to say, there is room for improvement in technology for providing parking information.

In view of the above circumstances, an object of the present disclosure is to improve parking information providing technology.

A parking information providing method according to an embodiment of the present disclosure is
a parking information providing method executed by an information processing device, the method including
acquiring information regarding a vehicle model that is desired by a customer, and information regarding a planned parking location,
determining whether the vehicle model that is desired by the customer is parkable at the planned parking location, based on the information regarding the vehicle model, the information regarding the planned parking location, and a database related to vehicle model information and parking location information, and
presenting determination results.

According to the embodiment of the present disclosure, parking information providing technology is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment; and

FIG. 2 is a flowchart showing operations of an information processing device.

### DETAILED DESCRIPTION OF EMBODIMENTS

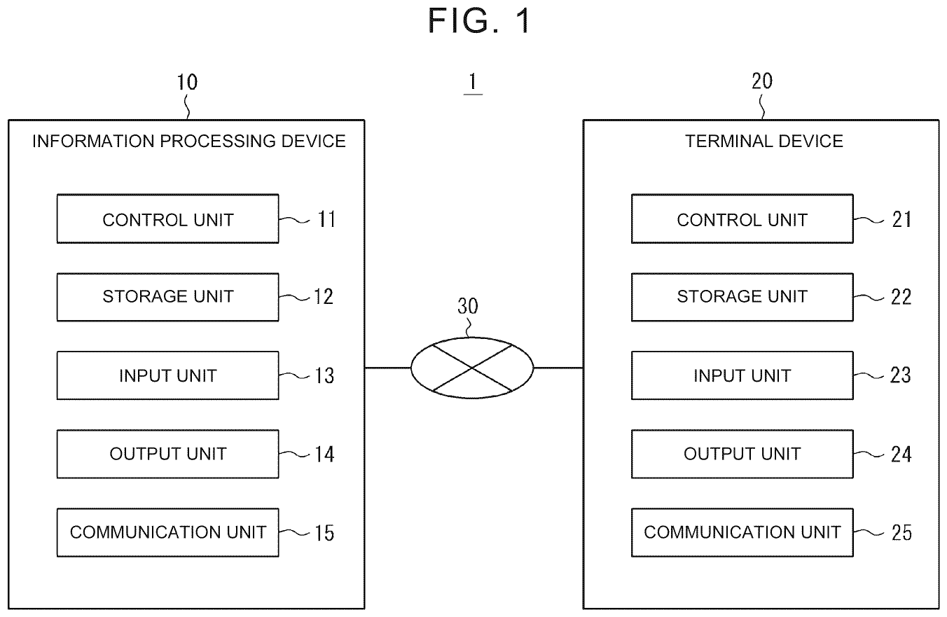

An embodiment of the present disclosure will be described below. An outline and a configuration of a system 1 according to the present embodiment will be described with reference to FIG. 1. The system 1 according to the present embodiment includes an information processing device 10 and a terminal device 20. The information processing device 10 is, for example, a server device that is installed in a data center or the like. The terminal device 20 is any device that is used by a user. These devices are communicatively connected via a network 30 such as the Internet or the like. Note that while FIG. 1 illustrates one each of the information processing device 10 and the terminal device 20, the system 1 may include a plurality of such devices.

First, an outline of the present embodiment will be described, and details will be described later. A parking information providing method according to the present embodiment is executed by the information processing device 10. The information processing device 10 acquires information regarding a vehicle model that is desired by a customer, and information regarding a planned parking location. The information processing device 10 also determines whether the vehicle model that is desired by the customer can be parked at the planned parking location based on the vehicle model information, the information regarding the planned parking location, and a database related to vehicle model information and parking location information. The information processing device 10 then presents determination results.

Thus, according to the present embodiment, the information processing device 10 determines whether the vehicle model that is desired by the customer can be parked at the planned parking location, based on the vehicle model information, the information regarding the planned parking location, and the database related to vehicle model information and parking location information, and presents determination results thereof. This improves parking information providing technology in that information regarding whether the vehicle can be parked at the location where the vehicle is planned to be used can be provided, which is important in business negotiations regarding vehicles.

Next, each configuration of the information processing device 10 and the terminal device 20 will be described in detail. As illustrated in FIG. 1, the information processing device 10 includes a control unit 11, a storage unit 12, an input unit 13, an output unit 14, and a communication unit 15. The control unit 11 includes at least one processor. The processor is a general-purpose processor such as a central processing unit (CPU) or the like, or a dedicated processor that is specialized for specific processing. The control unit 11 executes processing related to operations of the information processing device 10, while controlling the units of the information processing device 10. The storage unit 12 includes at least one semiconductor memory or the like. The semiconductor memory is, for example, random access memory (RAM) or read-only memory (ROM). The storage unit 12 functions as, for example, a main storage device or an auxiliary storage device. The storage unit 12 stores data that is used for the operation of the information processing device 10 and data that is acquired through the operation of the information processing device 10. The input unit 13 includes at least one input interface. The input interface may be, for example, physical keys, a touchscreen display, a sound sensor that accepts speech input, a camera that accepts gesture input, or the like. The input unit 13 receives operations for inputting data to be used for operations of the information processing device 10. The output unit 14 includes at least one output interface. The output interface is, for example, a display that outputs information as video, a speaker that outputs information as audio, or the like. The output unit 14 outputs data obtained by the operations of the information processing device 10. The communication unit 15 includes at least one external communication interface. The communication interface may be an interface for either wired communication or wireless communication. In the case of wired communication, the communication interface is, for example, a local area network (LAN) interface or a Universal Serial Bus (USB) interface. In the case of wireless communication, the communication interface is, for example, an interface compatible with mobile communication standards such as 5G or the like, or an interface that is compatible with near-field communication. The communication unit 15 receives data that is used for the operations of the information processing device 10, and also transmits data that is acquired through the operations of the information processing device 10.

Also, as illustrated in FIG. 1, the terminal device 20 includes a control unit 21, a storage unit 22, an input unit 23, an output unit 24, and a communication unit 25. The control unit 21 includes at least one processor. The processor is a general-purpose processor such as a central processing unit (CPU) or the like, or a dedicated processor that is specialized for specific processing. The control unit 21 executes processing related to the operation of the terminal device 20 while controlling each unit of the terminal device 20. The storage unit 22 includes at least one semiconductor memory or the like. The semiconductor memory is, for example, RAM or ROM. The storage unit 22 functions as, for example, a main storage device, an auxiliary storage device, or the like. The storage unit 22 stores data that is used for the operation of the terminal device 20 and data that is acquired through the operation of the terminal device 20. The input unit 23 includes at least one input interface. The input interface may be, for example, physical keys, a touchscreen display, a sound sensor that accepts speech input, a camera that accepts gesture input, or the like. The input unit 23 accepts an operation of inputting data that is used for the operation of the terminal device 20. The output unit 24 includes at least one output interface. The output interface is, for example, a display that outputs information as video, a speaker that outputs information as audio, or the like. The output unit 24 outputs the data that is acquired through the operation of the terminal device 20. The communication unit 25 includes at least one interface for external communication. The communication interface may be an interface for either wired communication or wireless communication. In the case of wired communication, the communication interface is, for example, a LAN interface or a USB interface. In the case of wireless communication, the communication interface is, for example, an interface compatible with mobile communication standards such as 5G or the like, or an interface that is compatible with near-field communication. The communication unit 25 receives the data that is used for the operation of the terminal device 20, and also transmits the data that is acquired through the operation of the terminal device 20.

The functions of the information processing device 10 or the terminal device 20 are realized by executing a program according to the present embodiment in a processor corresponding to the control unit 11 or the control unit 21. That is to say, the functions of the information processing device 10 or the terminal device 20 are realized by software. The program causes a computer to execute the operation of the information processing device 10 or the terminal device 20, thereby causing the computer to function as the information processing device 10 or the terminal device 20. That is to say, the computer functions as the information processing device 10 or the terminal device 20 by executing the operation of the information processing device 10 or the terminal device 20 in accordance with the program. In the present embodiment, the program can be recorded in a computer-readable recording medium. The computer-readable recording medium includes non-transitory computer-readable media, and is, for example, magnetic recording devices, semiconductor memory, and the like. Distribution of the program is carried out by, for example, selling, transferring, or leasing a portable recording medium such as a digital versatile disc (DVD) or the like in which the program is recorded. Also, the distribution of the program may be performed by storing the program in storage of an external server and transmitting the program from the external server to another computer. Further, the program may be provided as a program product. A part or all of the functions of the information processing device 10 or the terminal device 20 may be realized by dedicated circuits that are equivalent to the control unit 11 or the control unit 21. That is to say, part or all of the functions of the information processing device 10 or the terminal device 20 may be realized by hardware.

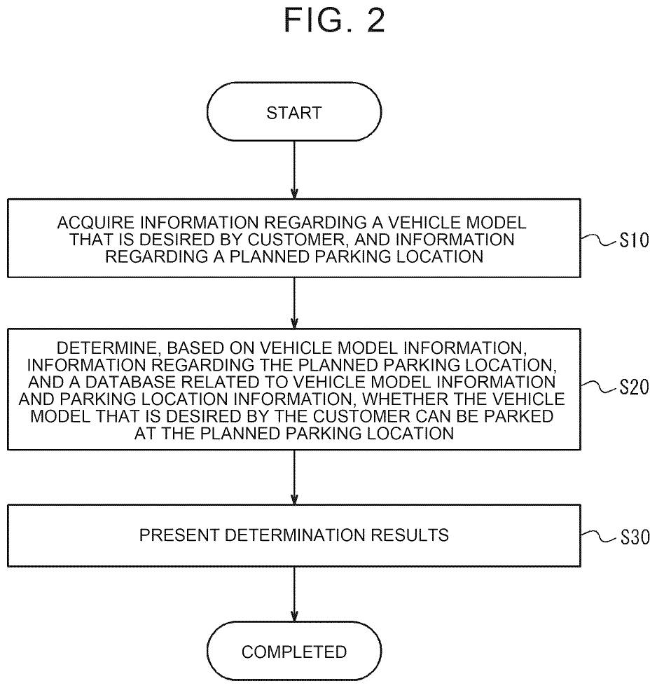

The operations of the information processing device 10 according to the present embodiment will be described with reference to FIG. 2. First, the control unit 11 of the information processing device 10 acquires information regarding the vehicle model that is desired by the customer and information regarding the planned parking location (step S10). The planned parking locations include residential areas such as apartment buildings or the like, stores such as shopping malls and so forth that are used by the customer, and the like.

Any technique can be employed for acquisition processing of information regarding the vehicle model that is desired by the customer and information regarding the planned parking location. For example, information regarding the vehicle model that is desired by the customer and information regarding the planned parking location may be acquired from voice data during business negotiations. Any technique can be employed for acquisition processing of the voice data. For example, the control unit 11 may acquire voice data from an external device or the like including the terminal device 20 via the communication unit 15 and the network 30. Furthermore, for example, the control unit 11 may acquire voice data via the input unit 13. In other words, the information regarding the vehicle model that is desired by the customer and the information regarding the planned parking location may be determined based on the voice data during the business negotiations.

Next, the control unit 11 determines whether the vehicle model that is desired by the customer can be parked at the planned parking location, based on the vehicle model information, the information regarding the planned parking location, and the database related to vehicle model information and parking location information (step S20). The database relating to vehicle model information and parking location information is a database of information regarding each parking location and information regarding vehicle models that can be parked at the parking location, which is accumulated based on past business negotiations, field surveys, and so forth. In other words, the database contains information reflecting physical constraints of the parking location (size of the parking space, height restrictions, etc.), the vehicle models that were actually selected by past customers, and general vehicle usage situation in the area.

Next, the control unit 11 presents determination results as to whether parking can be performed at the planned parking location, based on the determination processing in step S20 (step S30). Any technique can be employed for the processing of presenting the determination results. For example, the control unit 11 may transmit data to the terminal device 20 via the communication unit 15, and present the determination results via a user interface that is displayed and output by the output unit 24 of the terminal device 20. Alternatively, the control unit 11 may present the determination results via a user interface that is displayed and output by the output unit 14.

As described above, the information processing device 10 according to the present embodiment acquires the information regarding the vehicle model that is desired by the customer and information regarding the planned parking location. The information processing device 10 also determines whether the vehicle model that is desired by the customer can be parked at the planned parking location based on the vehicle model information, the information regarding the planned parking location, and the database related to vehicle model information and parking location information. The information processing device 10 then presents determination results.

Thus, according to the present embodiment, the information processing device 10 determines whether the vehicle model that is desired by the customer can be parked at the planned parking location, based on the vehicle model information, the information regarding the planned parking location, and the database related to vehicle model information and parking location information, and presents determination results thereof. This improves parking information providing technology in that information regarding whether the vehicle can be parked at the location where the vehicle is planned to be used can be provided, which is important in business negotiations regarding vehicles.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions and so forth that are included in the configurations, steps, and so forth, can be rearranged so as not to be logically inconsistent, and a plurality of configurations, steps, and so forth, can be combined into one, or can be divided.

For example, the vehicle model information may include minimum ground clearance information. The term “minimum ground clearance information” refers to the height from the bottom of a bumper of the vehicle to the ground. Note that the lower the minimum ground clearance is, the lower the center of gravity is, improving maneuverability and also making it easier for passengers to enter and exit the vehicle. When the vehicle model information includes the minimum ground clearance information, the control unit 11 of the information processing device 10 may present suggestion information for parking at the planned parking location. The suggestion information may include a parking method that does not cause the vehicle underside to come into contact with the ground. The suggestion information may also be used for the vehicle to travel. For example, a vehicle control device may execute automated parking assist during parking based on the suggestion information.

Further, for example, when parking at a planned parking location, the control unit 11 may output information regarding options that can and cannot be implemented, and tire information. This enables selecting optimal options based on parking constraints, and suggest tire sizes that suit the parking location, such that the customer can realize selection of a safe and efficient vehicle.

Further, for example, the control unit 11 may output vehicle models that are rivals to the vehicle model that is desired by the customer, and that cannot be parked at the planned parking location. This makes it easier for customers to narrow down their options, and can be used as a determination factor when selecting the appropriate vehicle model for the parking location.

Also, for example, the vehicle model information may include turning radius information. In this case, the control unit 11 may extract road information within a predetermined range from the planned parking location, and determine whether there are any locations where it would be difficult to travel based on the vehicle model information and the road information. The control unit 11 may also present the determination results. This allows customers to select in advance a vehicle model that is suitable for the road conditions in the vicinity of the parking location, enabling averting problems that arise when driving on narrow roads, around sharp curves, or the like.

Also, for example, in the above-described embodiment, an embodiment can be made in which the configuration and operation of the information processing device 10 is distributed between or among a plurality of computers that can communicate with each other.

What is claimed is:

1. A parking information providing method executed by an information processing device, the parking information providing method comprising:
acquiring information regarding a vehicle model that is desired by a customer, and information regarding a planned parking location;
determining whether the vehicle model that is desired by the customer is parkable at the planned parking location, based on the information regarding the vehicle model, the information regarding the planned parking location, and a database related to vehicle model information and parking location information; and
presenting determination results.

2. The parking information providing method according to claim 1, wherein at least one of the information regarding the vehicle model that is desired by the customer and the information regarding the planned parking location is acquired based on voice data during business negotiations.

3. The parking information providing method according to claim 1, wherein the planned parking location includes at least one of a residence of the customer and a store that is used by the customer.

4. The parking information providing method according to claim 1, wherein the database is constructed based on the information regarding the vehicle model that is desired by the customer, and the parking location information in voice data of a plurality of past business negotiations.

5. The parking information providing method according to claim 1, wherein
the information regarding the vehicle model includes minimum ground clearance information, and further,
the parking information providing method also includes presenting suggestion information for when parking at the planned parking location.
